(19) United States
(12) Patent Application Publication
(10) Pub. No.: US 2018/0291914 A1
(43) Pub. Date: Oct. 11, 2018

(54) FAN MOTOR

(71) Applicant: Nidec Corporation, Kyoto (JP)

(72) Inventors: Atsuyuki YAMAGUCHI, Kyoto (JP); Ryota HAYASHIDA, Kyoto (JP); Shoki YAMAZAKI, Kyoto (JP)

(21) Appl. No.: 15/924,533

(22) Filed: Mar. 19, 2018

(30) Foreign Application Priority Data
Apr. 7, 2017 (JP) 2017-076711

(51) Int. Cl. F04D 25/06; H02K 1/27; H02K 1/30; H02K 7/14; F04D 19/00; F04D 25/08; F04D 29/32; F04D 29/52

(52) U.S. Cl. CPC F04D 25/0606; H02K 1/2786; H02K 1/30; H02K 7/14; H02K 5/24; F04D 25/08; F04D 29/325; F04D 29/522; F04D 19/002

(57) ABSTRACT

A fan motor includes a rotating portion configured to rotate about a central axis that extends vertically. The rotating portion includes a rotor holder including a magnet and an impeller located outside the rotor holder and including a plurality of blades. The impeller includes a first member including a cylindrical portion located radially outside the rotor holder and a second member disposed above the first member. The first member includes a bottom at a lower end of the cylindrical portion, the bottom extending radially inward. At least part of an upper surface of the bottom faces a lower surface of the rotor holder in an axial direction.

### CROSS REFERENCE TO RELATED APPLICATIONS

This application claims the benefit of priority to Japanese Patent Application No. 2017-076711 filed on Apr. 7, 2017. The entire contents of this application are hereby incorporated herein by reference.

### BACKGROUND OF THE INVENTION

### 1. Field of the Invention

The present disclosure relates to a fan motor.

### 2. Description of the Related Art

In conventional fan motors, a fan unit is connected to a rotor unit using a plurality of connecting members. The fan unit includes a plurality of connecting holes into which the connecting members are to be inserted. The rotor unit includes a plurality of fixing holes into which the connecting members are to be inserted.

When the fan unit is rotated at high speed, a motor is likely to generate heat. When the fan unit and the rotor unit are fixed together with, for example, an adhesive, the fixed portions are susceptible to heat. This can cause the fan unit to be shifted from the rotor unit during high-speed rotation. The conventional fan motors are less susceptible to heat due to the use of the connecting members, so that the fan unit is unlikely to be shifted from the rotor unit. However, a plurality of connecting members are required for fixation, resulting in an increase in the number of components.

### SUMMARY OF THE INVENTION

The present disclosure provides a fan motor whose impeller hardly moves in the axial direction during driving of the motor.

A fan motor according to an aspect of the present disclosure includes a rotating portion configured to rotate about a central axis that extends vertically. The rotating portion includes a rotor holder including a magnet and an impeller located outside the rotor holder and including a plurality of blades. The impeller includes a first member including a cylindrical portion located radially outside the rotor holder and a second member disposed above the first member. The first member includes a bottom at a lower end of the cylindrical portion, the bottom extending radially inward. At least part of an upper surface of the bottom faces a lower surface of the rotor holder in an axial direction.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic cross-sectional view of the configuration of a fan motor according to a first embodiment of the present disclosure.

FIG. 2 is a schematic perspective view of the configuration of a first member.

FIG. 3 is a schematic perspective view of a second member viewed from above.

FIG. 4 is a schematic perspective view of the second member as viewed from below.

FIG. 5 is a schematic enlarged diagram illustrating the relationship among the first member, the second member, and a rotor holder.

FIG. 6 is a diagram for illustrating a first modification of the first embodiment.

FIG. 7 is a diagram for illustrating a second modification of the first embodiment.

FIG. 8 is a schematic cross-sectional view of the configuration of a fan motor according to a second embodiment of the present disclosure.

FIG. 9 is a schematic perspective view of the configuration of a first member.

FIG. 10 is a schematic perspective view of a second member viewed from above.

FIG. 11 is a diagram for illustrating a first modification of the second embodiment.

FIG. 12 is a diagram for illustrating a second modification of the second embodiment.

### DETAILED DESCRIPTION OF THE PREFERRED EMBODIMENTS

Embodiments of the present disclosure will be described hereinbelow with reference to the drawings. In this specification, a direction in which the central axis CA of the rotation of a rotating portion RP of a fan motor FM extends is referred to as “axial direction”. A direction perpendicular to the central axis CA of the fan motor FM is referred to as “radial direction”, and a direction along a circle centered on the central axis CA of the fan motor FM is referred to as “circumferential direction”. In this specification, the shapes of components and the positional relationship among the components will be described, with the axial direction defined as a vertical direction, and a direction from a rotor holder 3 toward an impeller 4 in the axial direction is defined as “upward”. However, this definition of the vertical direction is not intended to limit the orientation of the fan motor 1 according to the present disclosure in operation.

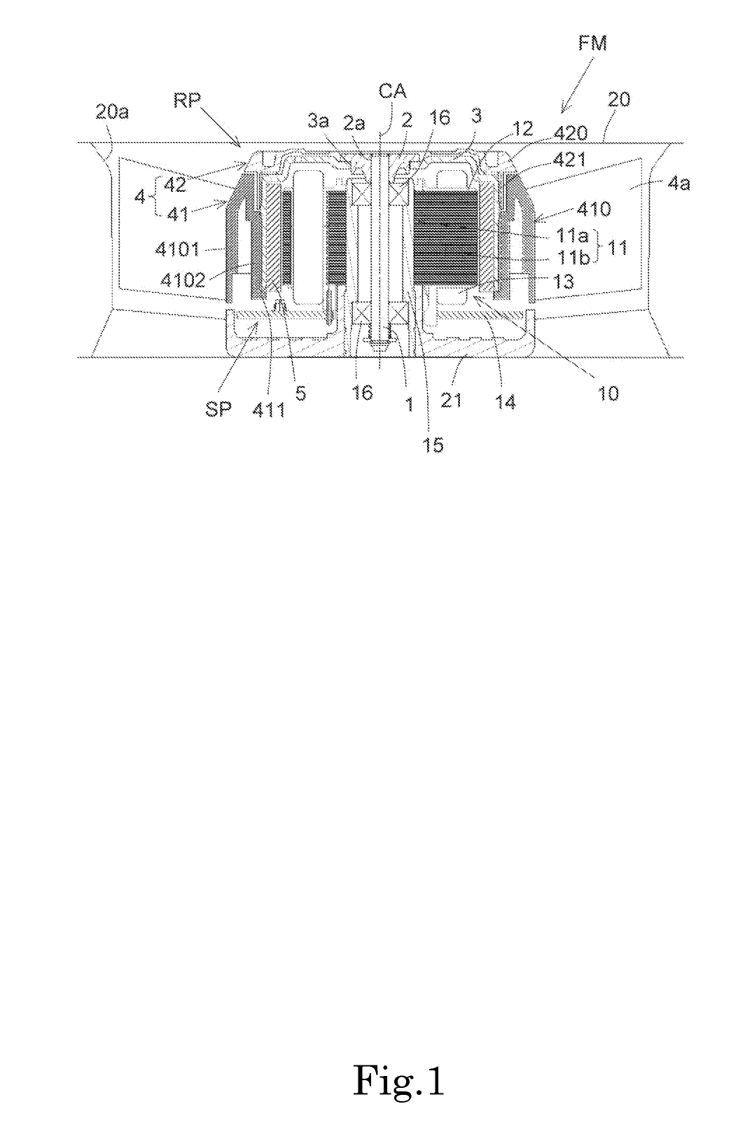

FIG. 1 is a schematic cross-sectional view of the configuration of a fan motor FM according to a first embodiment of the present disclosure. As illustrated in FIG. 1, the fan motor FM includes a rotating portion RP, a stationary portion SP, and a casing 20. The rotating portion RP and the stationary portion SP are housed in the casing 20. The casing 20 has a casing hole 20a, at the center, passing therethrough in the axial direction. The casing 20 includes a base 21 at the lower part of the casing hole 20a. The base 21 supports the stationary portion SP.

The rotating portion RP rotates about a vertically extending central axis CA. The rotating portion RP includes a shaft 1, a housing 2, a rotor holder 3, and an impeller 4.

The shaft 1 extends along the central axis CA. The shaft 1 is a columnar metal member. Alternatively, the shaft 1 may have another shape, such as a cylindrical shape.

The housing 2 supports the shaft 1. The housing 2 includes a housing hole 2a extending in the axial direction at the center. The shaft 1 is inserted in the housing hole 2a. The housing 2 is located at the upper part of the shaft 1. The shaft 1 is fixed to the housing 2. The housing 2 is made of metal, for example.

The rotor holder 3 is shaped like a cup that opens downward. The rotor holder 3 is made of a magnetic material, such as a carbon steel. The rotor holder 3 has a rotor hole 3a passing therethrough in the axial direction at the center of the upper surface thereof. The housing 2 is press-fitted into the rotor hole 3a. Thus, the rotor holder 3 is fixed to the housing 2. The shaft 1 rotates together with the rotor holder 3.

The rotor holder 3 includes a magnet 5. The magnet 5 is disposed around the inner circumferential surface of the rotor holder 3. In the present embodiment, the magnet 5 is a single ring-shaped magnet. The radially inner surface of the magnet 5 is magnetized to the north pole and the south pole alternately in the circumferential direction. Instead of the single ring-shaped magnet, a plurality of magnets may be disposed around the inner circumferential surface of the rotor holder 3. In this case, the plurality of magnets are disposed at regular intervals in the circumferential direction. The plurality of magnets are disposed such that the N pole face and the S pole face alternate in the circumferential direction. The rotor holder 3 and the magnet 5 may be formed as a single member with resin that contains magnetic powder.

The impeller 4 is disposed outside the rotor holder 3 and includes a plurality of blades 4a. The impeller 4 is fixed to the rotor holder 3. That is, the impeller 4 rotates about the central axis CA together with the rotor holder 3. The rotation of the impeller 4 causes a current of air. The details of the impeller 4 will be described later.

The stationary portion SP includes a stator 10. The stator 10 includes a stator core 11. An example of the stator core 11 is a laminated steel plate in which magnetic steel sheets are laminated in the axial direction. The stator core 11 includes a ring-shaped core back 11a and a plurality of teeth 11b extending radially outward from the core back 11a. A conductive wire is wound around each of the teeth 11b with an insulator 12 therebetween to form a coil 13. That is, the stator 10 includes a plurality of coils 13. One end of a conductive wire extracted from each coil 13 is electrically connected to a circuit board 14 disposed below the stator 10. The circuit board 14 is supplied with electric power from the outside.

The stationary portion SP includes a bearing holder 15. The bearing holder 15 is disposed radially inside the stator 10. The bearing holder 15 extends in the axial direction and is fixed to the stator 10. The bearing holder 15 includes two bearings 16 radially inside thereof. The bearings 16 are disposed at an upper position and a lower position. The upper and lower bearings 16 rotatably support the rotating portion RP with respect to the stationary portion SP. The bearings 16 are fixed to the outer circumference of the shaft 1. In the present embodiment, the bearings 16 are ball bearings.

In the fan motor FM with the above configuration, when electric power is supplied to the coils 13, magnetic flux is generated in the teeth 11b. A circumferential torque is generated by the action of the magnetic flux between the teeth 11b and the magnet 5. This causes the rotating portion RP to rotate about the central axis CA with respect to the stationary portion SP to start the rotational operation of the fan motor FM. The rotation of the rotating portion RP includes the rotation of the impeller 4, so that a current of air is generated. When the power supply to the coils 13 is stopped, the rotation of the rotating portion RP stops. As a result, the rotational operation of the fan motor FM ends.

As illustrated in FIG. 1, the impeller 4 includes a first member 41 and a second member 42. In the present embodiment, the first member 41 and the second member 42 are formed of resin. The resin constituting the first member 41 and the resin constituting the second member 42 are the same material. The resin constituting the first member 41 and the resin constituting the second member 42 may be different materials.

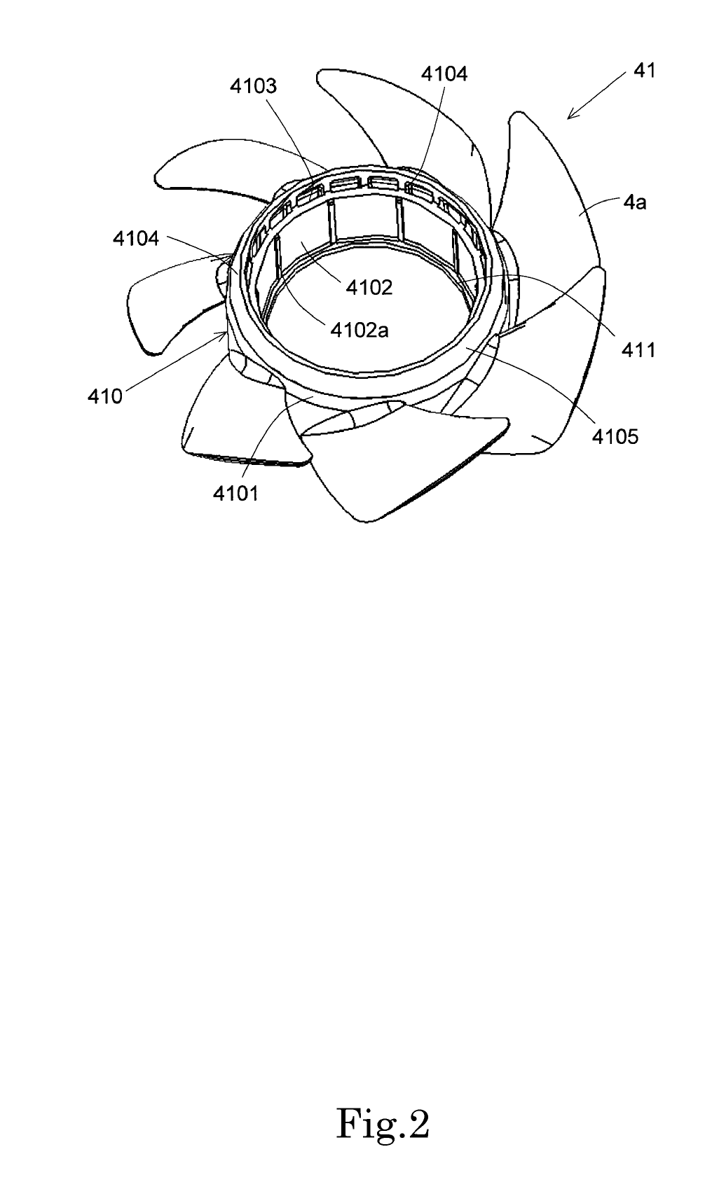

FIG. 2 is a schematic perspective view of the configuration of the first member 41. As illustrated in FIGS. 1 and 2, the first member 41 includes a cylindrical portion 410 located radially outside the rotor holder 3. Specifically, the cylindrical portion 410 is has a cylindrical shape. The cylindrical portion 410 is fixed to the rotor holder 3. A plurality of blades 4a are provided around the outer circumferential surface of the cylindrical portion 410. In the present embodiment, the number of the blades 4a is seven. The number of the blades 4a may be changed as appropriate. The cylindrical portion 410 and the blades 4a are made of a single member. The blades 4a extend from the outer circumferential surface of the cylindrical portion 410 in a direction including a radial component.

Specifically, the cylindrical portion 410 includes a first side wall 4101 and a second side wall 4102. The first side wall 4101 and the second side wall 4102 has a cylindrical shape. The first side wall 4101 is connected to the inner ends of the blades 4a. The second side wall 4102 is located radially inside the first side wall 4101. The cylindrical portion 410 includes axial through-holes 4103 between the first side wall 4101 and the second side wall 4102. The through-holes 4103 can be used to evacuate heat generated inside due to the driving of the fan motor FM to the outside.

A plurality of connecting pieces 4104 connecting the first side wall 4101 and the second side wall 4102 together are disposed between the first side wall 4101 and the second side wall 4102. The plate-like connecting pieces 4104 extend in the axial direction. The dimension in the circumferential direction of the connecting pieces 4104 is smaller than the dimension in the axial direction as viewed from the axial direction. The connecting pieces 4104 are arranged at intervals in the circumferential direction. The number of the connecting pieces 4104 is not particularly limited and may be any number as long as it ensures the strength with which the first side wall 4101 and the second side wall 4102 are connected. The plurality of connecting pieces 4104 are preferably disposed at regular intervals in the circumferential direction. Specifically, the through-holes 4103 are separated in the circumferential direction by the plurality of connecting pieces 4104.

The second side wall 4102 faces the rotor holder 3 in the radial direction. A plurality of first ribs 4102a extending in the axial direction are disposed around the inner circumferential surface of the second side wall 4102. The first ribs 4102a are disposed in the circumferential direction. The plurality of first ribs 4102a are preferably disposed at regular intervals in the circumferential direction. The first ribs 4102a may be in direct-contact with the rotor holder 3. The first ribs 4102a apply a radially inward force to the outer circumferential surface of the rotor holder 3. In other words, the rotor holder 3 is press-fitted in the first member 41. In other words, the first member 41 is fixed to the rotor holder 3. At positions where the first ribs 4102a are not provided, a gap may be formed between the inner surface of the second side wall 4102 and the outer circumferential surface of the rotor holder 3. The number of the first ribs 4102a is not particularly limited. The number is preferably any number that ensures strength necessary for fixing the first member 41 to the rotor holder 3.

It is also possible that the surfaces of the plurality of first ribs 4102a are coated with an adhesive and that the rotor holder 3 is press-fitted in the first member 41. This allows the first member 41 to be fixed to the rotor holder 3 by press-fitting and bonding, thereby increasing the strength of fixing the first member 41 to the rotor holder 3. In this configuration, the first ribs 4102a may be in indirect-contact with the rotor holder 3 via an adhesive. Part of the first ribs 4102a may be in direct-contact with the rotor holder 3. As another alternative, the first ribs 4102a may not be provided on the second side wall 4102, and the first member 41 may be fixed to the rotor holder 3 only with an adhesive.

As still another alternative, one of the inner circumferential surface of the second side wall 4102 and the outer circumferential surface of the rotor holder 3 may have protruding portions, and the other may have recessed portions so that the protruding portions and the recessed portions are engaged with each other. This prevents the first member 41 from rotating with respect to the rotor holder 3. The first member 41 may be fixed to the rotor holder 3 only by the engagement between the protruding portion and the recessed portion. In addition to the engagement between the protruding portion and the recessed portion, at least one of press-fitting and an bonding may be used to fix the first member 41 and the rotor holder 3.

The first member 41 includes a bottom 411 that extends radially inward at the lower end of the cylindrical portion 41. At least part of the upper surface of the bottom 411 faces the lower surface of the rotor holder 3 in the axial direction. In other words, at least part of the bottom 411 overlaps with the rotor holder 3 in plan view from the axial direction. With this configuration, when the first member 41 including the blades 4a is going to rise with respect to the rotor holder 3, the bottom 411 abuts against the rotor holder 3, thereby preventing the first member 41 from rising. The upper surface of the bottom 411 and the lower surface of the rotor holder 3, which face each other, may be parallel flat surfaces. One of the surfaces may be inclined with respect to the other. At least one of the surfaces may be a curved surface.

Specifically, the second side wall 4102 includes the bottom 411. The bottom 411 extends radially inward from the inner circumferential surface at the lower end of the second side wall 4102. In the present embodiment, the position of the radially inner end of the bottom 411 and the position of the inner circumferential surface of the rotor holder 3 in the radial direction are the same. The lower surface of the rotor holder 3 and the upper surface of the bottom 411 may be in contact with each other. This prevents the first member 41 from being shifted upward with respect to the rotor holder 3 because of the rotor holder 3 and the first member 41 are in contact with each other in the vertical direction.

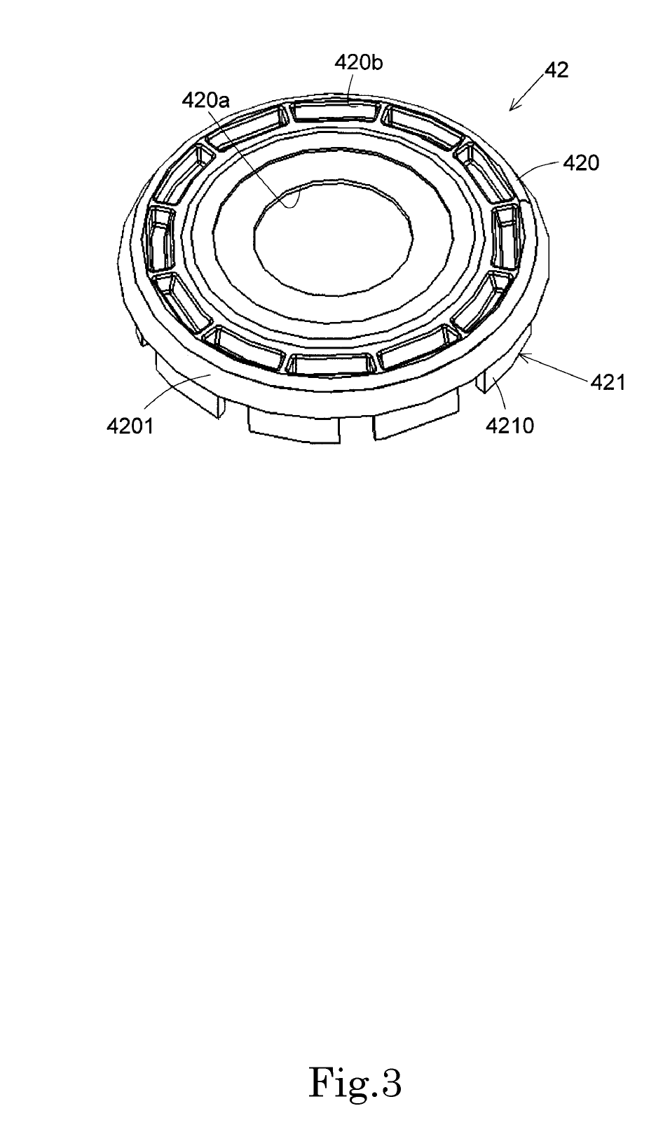

FIG. 3 is a schematic perspective view of the second member 42 viewed from above. The second member 42 is disposed above the first member 41. In the present embodiment, the impeller 4 is divided into the first member 41 and the second member 42, so that the impeller 41 including the bottom 411 can easily be formed by resin molding using a mold. Specifically, since the impeller 4 is divided into the first member 41 and the second member 42, the impeller 4 can be formed using a mold that is pulled in the vertical direction. In the fan motor FM of the present embodiment, the impeller 4 has the bottom 411, so that the number of components for fixing the impeller 4 to the rotor holder 3 can be decreased. For example, the present embodiment does not need fastening devices, such as screws, when fixing the impeller 4 to the rotor holder 3.

The second member 42 includes a top face 420 and a protruding portion 421. The top face 420 extends in the radial direction. In the present embodiment, the top face 420 is circular in plan view from above in the axial direction. The top face 420 includes a top hole 420a passing therethrough in axial direction at the center thereof. The top hole 420a has a circular shape.

The upper surface of the top face 420 includes a plurality of recessed portions 420b that are recessed downward. The plurality of recessed portions 420b are arranged at intervals in the circumferential direction. Each recessed portion 420b extends in the circumferential direction. The recessed portions 420b are shorter in the radial direction than in the circumferential direction as viewed from the axial direction. In the present embodiment, the plurality of recessed portions 420b have the same shape and the same size. The plurality of recessed portions 420b are disposed on an outer circumference side of the top face 420 adjacent to the outer circumference. The plurality of recessed portions 420b are arranged at regular intervals in the circumferential direction. In the present embodiment, the number of the recessed portions 420b is 12. However, the number of the recessed portions 420b is not limited to 12. The balance of the impeller 4 can be adjusted by filling part of the plurality of recessed portions 420b with a member for adjusting the balance. An example of the member for adjusting the balance is clay.

The protruding portion 421 extends downward from the top face 420. The outer circumferential surface of the rotor holder 3 and the radially inner surface of the protruding portion 421 face each other in the radial direction. This allows the second member 42 to be fixed to the rotor holder 3 by press fitting. The second member 42 can also be fixed to the rotor holder 3 by adhesion. The second member 42 can also be fixed to the rotor holder 3 by press fitting and adhesion.

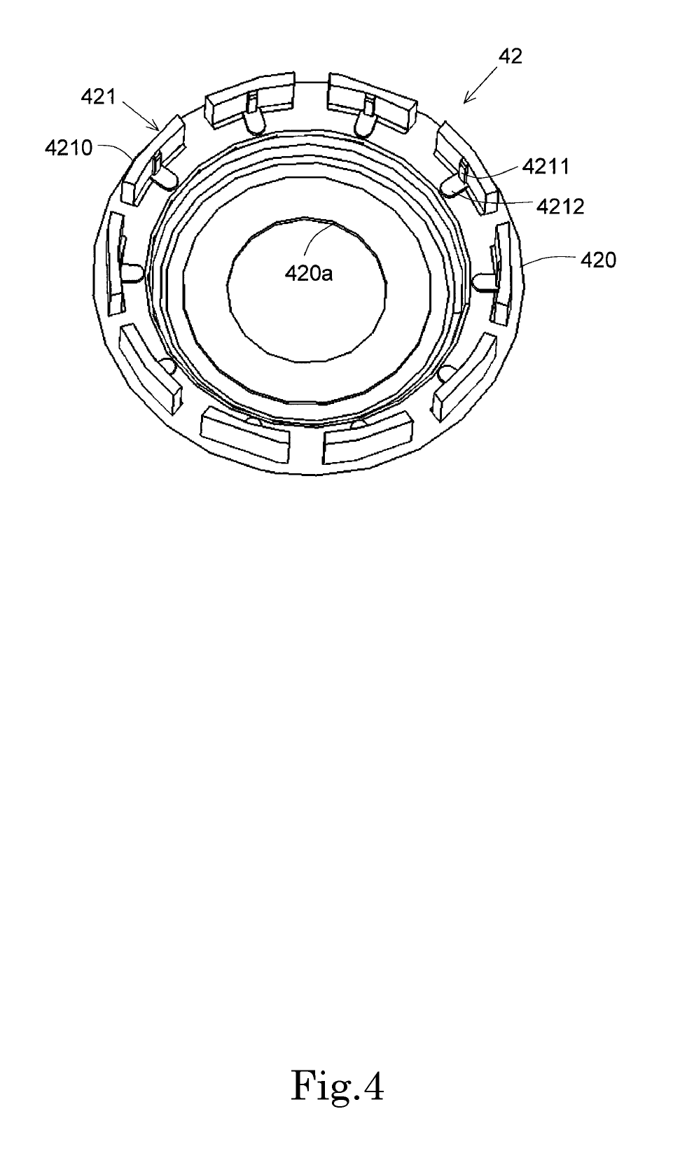

FIG. 4 is a schematic perspective view of the second member 42 as viewed from below. As illustrated in FIGS. 3 and 4, the protruding portion 421 includes a plurality of protruding pieces 4210 arranged at intervals in the circumferential direction. This allows the heat generated in the interior due to driving of the fan motor FM to be let out through the gap between adjacent protruding pieces 4210. For example, air containing heat generated in the motor passes through the gap between the adjacent protruding pieces 4210 and is let out through the through-holes 4103.

Although the number of the plurality of protruding pieces 4210 is 10 in the present embodiment, the number may be another number. In the present embodiment, the plurality of protruding pieces 4210 have the same shape and the same size. The plurality of protruding pieces 4210 are preferably disposed at regular intervals in the circumferential direction. However, the protruding portion 421 may be a single ring-shaped member.

A second rib 4211 extending in the axial direction is provided radially inside each of the protruding pieces 4210. The second rib 4211 is disposed at the center of each protruding piece 4210 in the circumferential direction. The second ribs 4211 may be in direct-contact with the rotor holder 3. The second ribs 4211 apply a radially inward force to the outer circumferential surface of the rotor holder 3. That is, the rotor holder 3 is press-fitted in the second member 42. In other words, the second member 42 is fixed to the rotor holder 3. At a position where each second rib 4211 is not provided, a gap may be formed between the inner surface of each protruding piece 4210 and the outer circumferential surface of the rotor holder 3. The number of the second ribs 4211 is not particularly limited. However it is preferable that the number ensures the strength required for fixing the second member 42 to the rotor holder 3.

The surfaces of the plurality of second ribs 4211 may be coated with an adhesive, and the rotor holder 3 may be press-fitted in the second member 42. This allows the second member 42 to be fixed to the rotor holder 3 by press-fitting and adhesion, increasing the strength of fixing the second member 42 to the rotor holder 3. In this configuration, the second ribs 4211 may be in indirect-contact with the rotor holder 3 via an adhesive. Part of the second ribs 4211 may be in direct-contact with the rotor holder 3. In another configuration, the second ribs 4211 may not be provided at the second member 42, and the second member 42 may be fixed to the rotor holder 3 only with an adhesive.

In the present embodiment, the second member 42 does not include the blades 4a. Because of this, even when the impeller 4 is rotated at high speed, a centrifugal force applied to the second member 42 is smaller than a centrifugal force applied to the first member 41. For that reason, even if the second member 42 is fixed to the rotor holder 3 only by press-fitting or adhesion, deviation from the rotor holder 3 hardly occurs.

As illustrated in FIG. 4, small protrusions 4212 protruding downward are provided on the lower surface of the top face 420. The axial dimension of each small protrusion 4212 is smaller than the axial dimension of the protruding portion 421.

The small protrusion 4212 is positioned radially inside each protruding portion 421. In the present embodiment, the plurality of small protrusions 4212 are disposed at the same intervals as that of the protruding pieces 4210 in the circumferential direction.

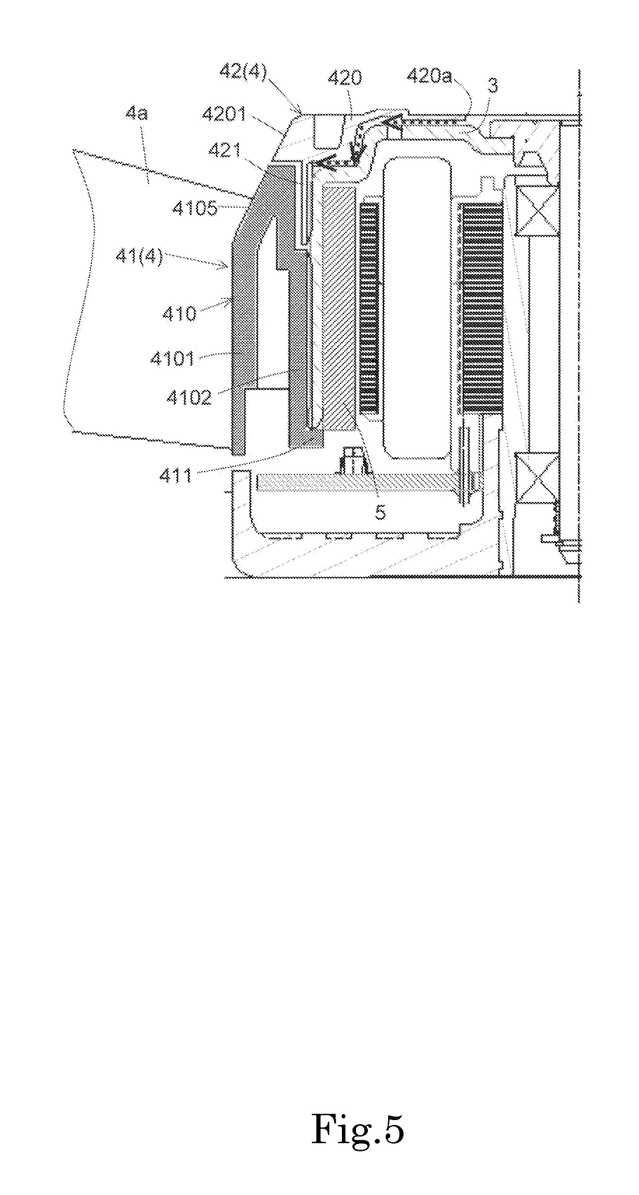

FIG. 5 is a schematic enlarged diagram illustrating the relationship among the first member 41, the second member 42, and the rotor holder 3. The lower surfaces of the small protrusions 4212 are in contact with the upper surface of the rotor holder 3. The second member 42 and the rotor holder 3 can be positioned in the axial direction using the small protrusions 4212. A gap is provided between the lower surface of the top face 420a and the upper surface of the rotor holder 3 because of the presence of the small protrusions 4212. Air passes through the gap, so that heat radiation is performed. For example, as indicated by the broken-line arrow in FIG. 5, the air that entered through the top hole 420a into the interior enters the gap between the lower surface of the top face 420 and the upper surface of the rotor holder 3. This air passes through the gap between the adjacent small protrusions 4212 and the gap between the adjacent protruding pieces 4210 into the through-holes 4103.

As illustrated in FIG. 1, the upper surface of the second side wall 4102 is positioned lower than the upper surface of the first side wall 4101. That is, there is a space where the second side wall 4102 is not present inside the upper portion of the first side wall 4101. The protruding portion 421 is housed in the space. The lower surface of the protruding portion 421 and the upper surface of the second side wall 4202 face each other in the axial direction. The radially outer side of the protruding portion 421 and the radially inner surface of the first side wall 4101 face each other in the radial direction. In this configuration, the first side wall 4101 and the protruding portion 421 have an overlapping portion in the vertical direction. For that reason, the thickness in the vertical direction of the impeller 4 constituted by the first member 41 and the second member 42 can be small.

The lower surface of the protruding portion 421 and the upper surface of the second side wall 4202, which face in the axial direction, may or may not be in contact with each other. However, the distance between the surfaces is preferably as small as possible. This increases the axial length of the protruding portion 421, thereby increasing the strength of fixing the second member 42 to the rotor holder 3.

The protruding portion 421 is located radially inside the radially outer end of the top face 420. That is, the top face 420 includes a portion extending radially outward from the protruding portion 421. The lower surface of the radially outer end of the top face 420 and the upper surface of the first side wall 4101 may be in contact with each other. Thus, no gap is formed between the cylindrical portion 410 and the top face 420 on the outer circumferential side, thereby preventing disturbance of the current of air along the outer circumferential surface of the cylindrical portion 410 and the top face 420. This prevents generation of noise when the fan motor FM is driven.

A gap may be provided between the lower surface of the radially outer end of the top face 420 and the upper surface of the first side wall 4101. This ensures a passage for letting out the heat generated in the fan motor FM.

As illustrated in FIG. 5, the upper part of the outer circumferential surface of the first side wall 4101 includes a first inclined surface 4105 inclined with respect to the central axis CA. Specifically, the distance from the outer circumferential surface of the first inclined surface 4105 to the central axis CA increases from the top to the lower part. The radially outer end face of the top face 420 includes a second inclined surface 4201 inclined with respect to the central axis CA. Specifically, the distance between the outer circumferential surface of the second inclined surface 4201 and the central axis CA increases from the top to the bottom. That is, the first inclined surface 4105 and the second inclined surface 4201 are inclined in the same direction.

More specifically, the first inclined surface 4105 and the second inclined surface 4201 are inclined at the same angle. The first inclined surface 4105 and the second inclined surface 4201 are preferably flush with each other and connected without a gap. This enables the fan motor FM to make intake air flow along the inclined surfaces 4105 and 4201 without causing turbulence, allowing efficient blowing of air.

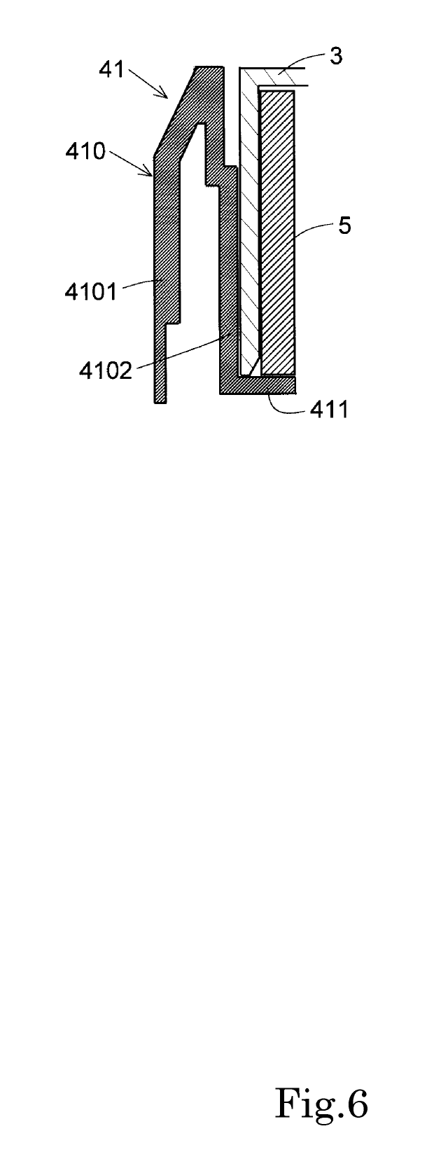

FIG. 6 is a diagram for illustrating a first modification of the first embodiment. As illustrated in FIG. 6, the magnet 5 of the first modification is also disposed on the inner circumferential surface of the rotor holder 3. However, in this modification, the lower surface of the magnet 5 and the upper surface of the bottom 411 face in the axial direction, unlike the first embodiment. In other words, the bottom 411 overlaps with the magnet 5 in plan view from the axial direction.

In this modification, the bottom 411 extends radially inward across the inner circumferential surface of the rotor holder 3. The upper surface of the bottom 411 axially face both of the lower surface of the rotor holder 3 and the lower surface of the magnet 5. With the configuration of this modification, when the first member 41 including the blades 4a is going to rise with respect to the rotor holder 3, the bottom 411 abuts against not only the rotor holder 3 but also the magnet 5. This prevents the first member 41 from shifting in the axial direction with respect to the rotor holder 3.

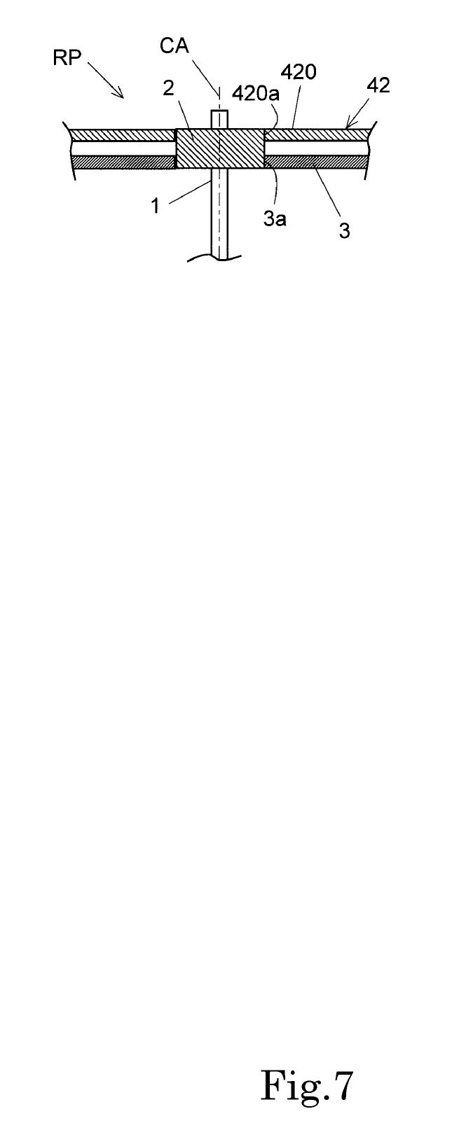

FIG. 7 is a diagram for illustrating a second modification of the first embodiment. As illustrated in FIG. 7, also the rotating portion RP of the this modification includes the shaft 1 extending along the central axis CA and the housing 2 that supports the shaft 1. The rotor holder 3 is fixed to the housing 2 by press-fitting part of the housing 2 in the rotor hole 3a. The second member 42 includes the top face 420 extending in the radial direction.

In this modification, the housing 2 and the top face 420 are joined together, unlike the first embodiment. For example, the housing 2 and the top face 420 are joined together by insert molding. Specifically, at least part of the outer circumferential surface of the housing 2 is subjected to knurling, and the knurled portion and the inner circumferential surface of the top hole 420a are joined together by insert molding. With the configuration of this modification, the second member 42 is joined to the housing 2 fixed to the rotor holder 3, so that it is hardly displaced with respect to the rotor holder 3. In this modification, the second member 42 may be press-fitted in the rotor holder 3. The second member 42 may be fixed to the rotor holder 3 with an adhesive. The second member 42 may be fixed to the rotor holder 3 by both of press-fitting and adhesion.

The housing 2 preferably has a sufficient axial length to fix both of the top face 420 and the rotor holder 3 arranged in the axial direction. For example, the axial dimension of the housing 2 is preferably larger than the total of the axial dimension of the top face 420 and the axial dimension of the rotor holder 3. The top face 420 is preferably out of contact with the rotor holder 3 at least in the vicinity of the housing 2. The top face 420 preferably has no bent portion at least in the vicinity of the housing 2. This prevents generation of a crack in the second member 42 during cooling after insert molding.

The outline of the fan motor FM is the same as that of the first embodiment. The first embodiment and the second embodiment differ in the configuration of the impeller 4. Hereinafter, a description will be given focusing on differences from the first embodiment, and descriptions of components overlapping with the first embodiment will be omitted when no particular description is needed.

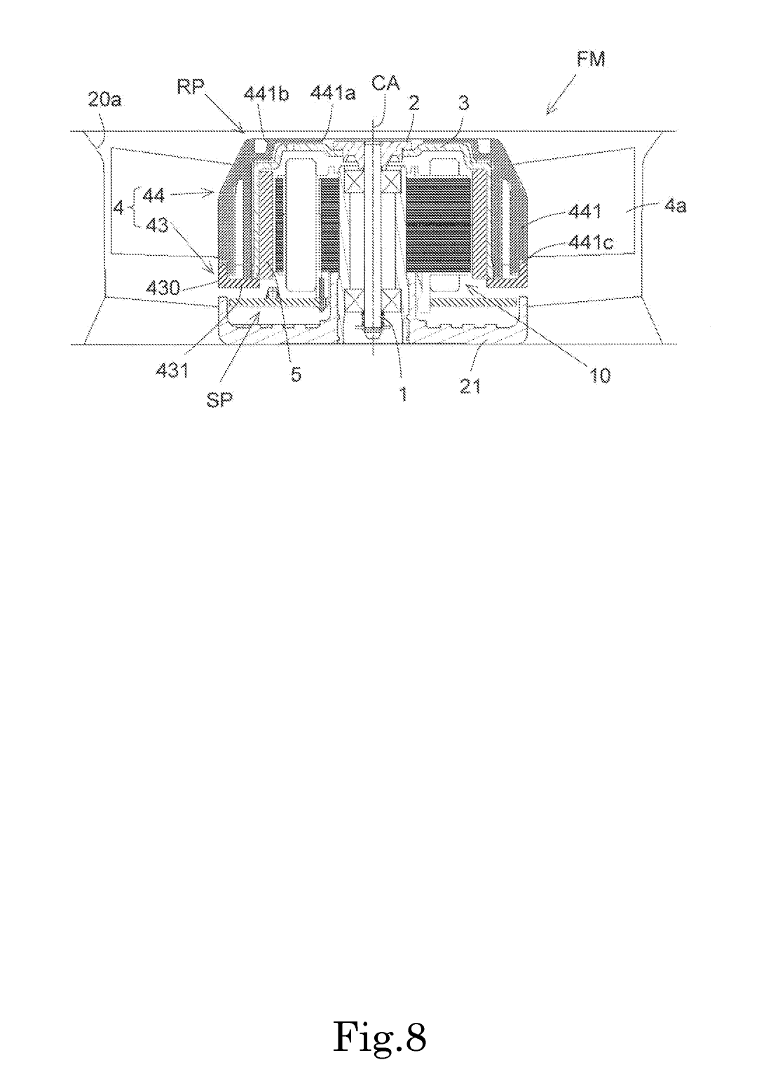

FIG. 8 is a schematic cross-sectional view of the configuration of a fan motor FM according to a second embodiment of the present disclosure. As illustrated in FIG. 8, the impeller includes a first member 43 and a second member 44. In the present embodiment, the first member 43 and the second member 44 are made of resin. The resin constituting the first member 43 and the resin constituting the second member 44 are the same material. The resin constituting the first member 43 and the resin constituting the second member 44 may be different materials.

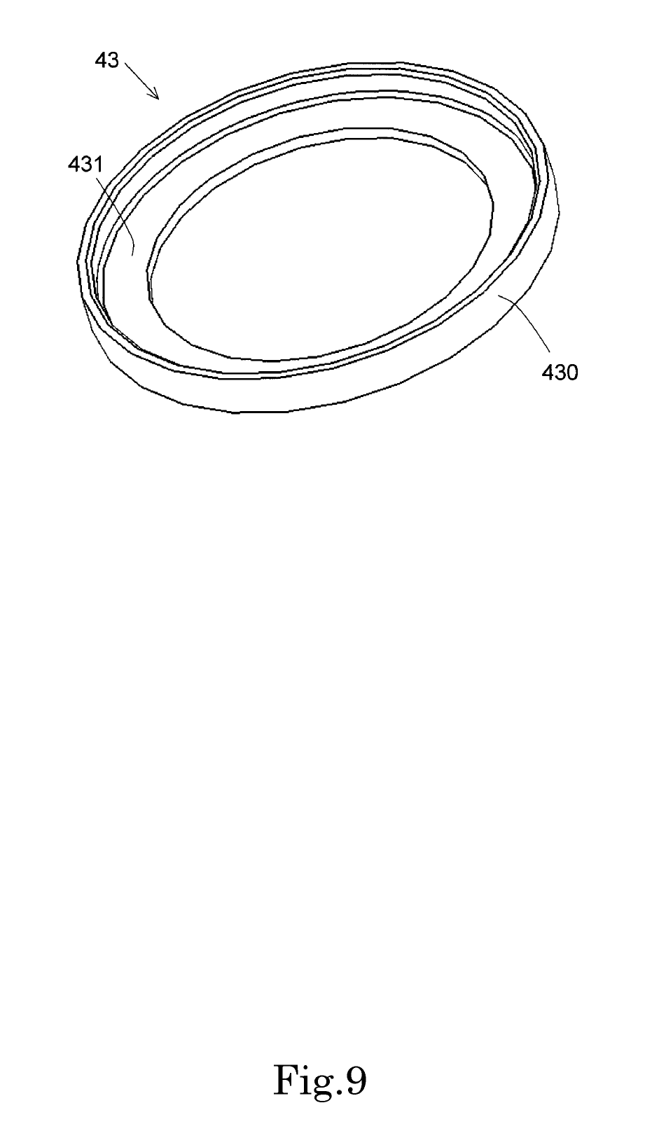

FIG. 9 is a schematic perspective view of the configuration of the first member 43. As illustrated in FIGS. 8 and 9, the first member 43 includes a cylindrical portion 430 radially outside the rotor holder 3. Specifically, the cylindrical portion 430 has a cylindrical shape extending in the axial direction. The first member 43 includes a bottom 431 extending radially inward at the lower end of the cylindrical portion 430. At least part of the upper surface of the bottom 431 faces the lower surface of the rotor holder 3 in the axial direction. In other words, at least part of the bottom 431 overlaps with the rotor holder 3 in plan view from the axial direction. When the first member 43 is going to rise with respect to the rotor holder 3, the bottom 431 abuts against the rotor holder 3, so that the rising of the first member 43 can be prevented. The upper surface of the bottom 431 may also face the lower surface of the magnet 5. The lower surface of the rotor holder 3 and the upper surface of the bottom 431 are preferably in contact with each other, they may be out of contact with each other.

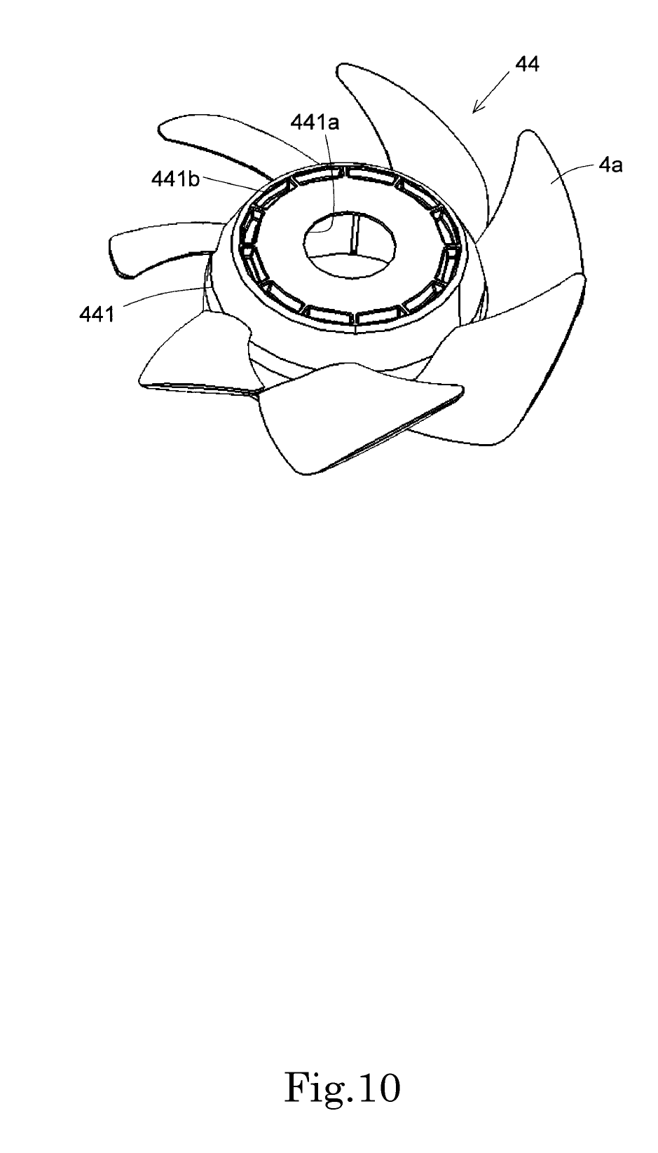

FIG. 10 is a schematic perspective view of the second member 44 viewed from above. As illustrated in FIGS. 8 and 10, the second member 44 is disposed above the first member 43. The second member 44 includes a cup portion 441 and a plurality of blades 4a. The cup portion 441 opens downward and houses the rotor holder 3. In the present embodiment, the cup portion 441 is circular in outer circumference and inner circumference in plan view from the axial direction. The plurality of blades 4a are provided around the outer circumferential surface of the cup portion 441. The number of the plurality of blades 4a is not particularly limited. The cup portion 441 and the blades 4a are formed of a single member. The blades 4a extends from the outer circumferential surface of the cup portion 441 in a direction containing a radial component. The cup portion 441 has a circular cup hole 441a at the center of the upper surface. The cup portion 441 has a plurality of downwardly recessed portions 441b around the outer rim of the upper surface thereof. The plurality of recessed portions 441b are disposed at regular intervals in the circumferential direction. The recessed portions 441b can be used for adjusting the balance.

The inner circumferential surface of the cup portion 441 and the outer circumferential surface of the rotor holder 3 face each other in the radial direction. In the present embodiment, the rotor holder 3 is press-fitted in the interior of the cup portion 441. The inner circumferential surface of the cup portion 441 and the outer circumferential surface of the rotor holder 3 may be in direct-contact with each other or may be in contact with each other via an adhesive. The cup portion 441 may be fixed to the rotor holder 3 not by press-fitting but only with an adhesive. In the case of press-fitting, ribs extending in the axial direction may be provided on the inner circumferential surface of the cup portion 441. The cup portion 441 may be joined to the housing 2 by insert molding. A gap for let out heat may be provided between the cup portion 441 and the rotor holder 3.

The lower surface of the cup portion 441 and the upper surface of the bottom 431 face each other in the axial direction. The inner circumferential surface of the cylindrical portion 430 and the outer circumferential surface of the cup portion 441 face each other in the radial direction. In the present embodiment, the lower portion of the cup portion 441 is press-fitted in the interior of the cylindrical portion 430. That is, the first member 43 is fixed to the second member 44. The outer circumferential surface of the cup portion 441 and the inner circumferential surface of the cylindrical portion 430 may be in direct-contact with each other or may be in contact via an adhesive. The cup portion 441 may not be press-fitted in the cylindrical portion 430 but may be fixed only with an adhesive. In the case of press-fitting, the inner circumferential surface of the cylindrical portion 430 may be provided with ribs extending in the axial direction.

More specifically, the cup portion 441 includes a step portion 441c at which the radius from the central axis CA to the outer circumferential surface changes. Specifically, the step portion 441c is positioned at the boundary at which the radius of the cup portion 441 from the central axis CA to the outer circumferential surface changes from one radius to another radius. The radius of a portion lower than the step portion 441c is smaller than the radius of a portion higher than the step portion 441c. The cylindrical portion 430 is located lower than the step portion 441c. The inner circumferential surface of the cylindrical portion 430 faces an outer circumferential surface of the cup portion 441 lower than the step portion 441. An outer circumferential surface of the cup portion 441 higher than the step portion 441 and the outer circumferential surface of the cylindrical portion 430 are flush with each other. The upper surface of the cylindrical portion 430 is preferably in contact with the lower end face of the cup portion 441. With this configuration, the fan motor FM can make intake air efficiently flow along the outer circumferential surfaces of the cup portion 441 and the cylindrical portion 430.

In the configuration of the present embodiment, the second member 44 including the blades 4a is disposed radially inside the cylindrical portion 430, so that the second member 44 can receive a radially inward force from the first member 43. Because of that, even when a centrifugal force directed radially outward acts on the second member 44 due to the high-speed rotation of the impeller 4, the second member 44 can be held by the first member 43, preventing the second member 44 from being shifted from the rotor holder 3.

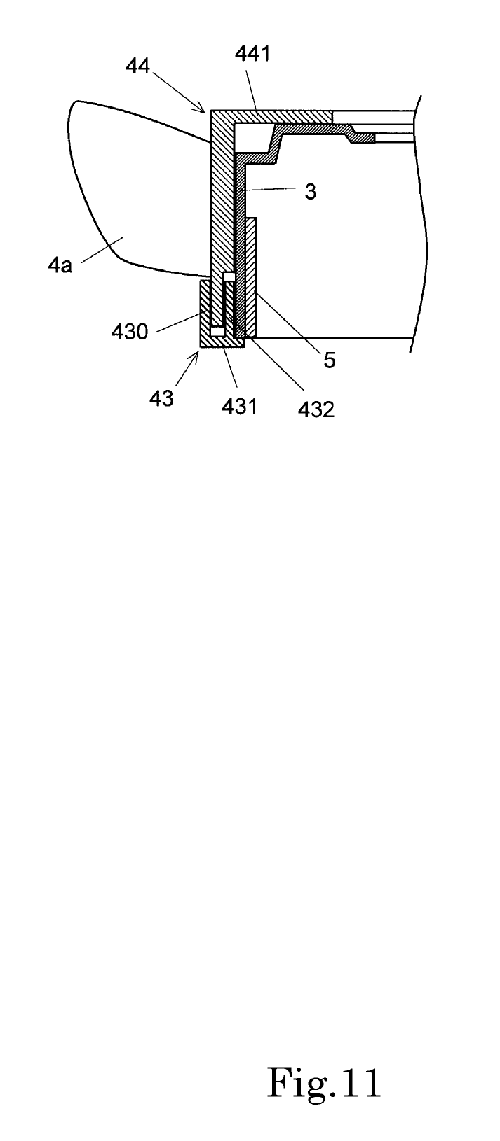

FIG. 11 is a diagram for illustrating a first modification of the second embodiment. As illustrated in FIG. 11, the first member 43 of this modification also includes the cylindrical portion 430 and the bottom 431 extending radially inward at the lower end of the cylindrical portion 430. However, unlike the second embodiment, the bottom 431 includes a wall 432 extending upward radially inside the cylindrical portion 430. In this modification, the wall 432 has a cylindrical shape. The radially inner surface of the wall 432 faces the outer circumferential surface of the rotor holder 3 in the radial direction.

The rotor holder 3 may be press-fitted in the first member 43, with its outer circumferential surface in contact with the radially inside surface of the wall 432. This allows the first member 43 to be fixed to the rotor holder 3. In this configuration, the radially inner surface of the wall 432 may be provided with ribs extending in the axial direction. In another configuration, the outer circumferential surface of the rotor holder 3 may be bonded to the radially inner surface of the wall 432 with an adhesive. This allows the first member 43 to be fixed to the rotor holder 3. Also in this configuration, for example, the radially inner surface of the wall 432 may be provided with ribs extending in the axial direction, and the rotor holder 3 may be press-fitted in the first member 43.

In this modification, the cup portion 441 is located between the cylindrical portion 430 and the wall 432. Specifically, the lower part of the cup portion 441 is located between the inner circumferential surface of the cylindrical portion 430 and the radially outer surface of the wall 432. This allows the second member 44 including the blades 4a to be fixed to the first member by press-fitting the second member 44 between the inner circumferential surface of the cylindrical portion 430 and the radially outer surface of the wall 432. In another embodiment, the second member 44 including the blades 4a may be fitted between the inner circumferential surface of the cylindrical portion 430 and the radially outer surface of the wall 432 and may be fixed to the two surfaces with an adhesive. In this case, fixation with an adhesive and fixation by press-fitting may be used together. That is, a force of holding the second member 44 with the first member 43 can be increased.

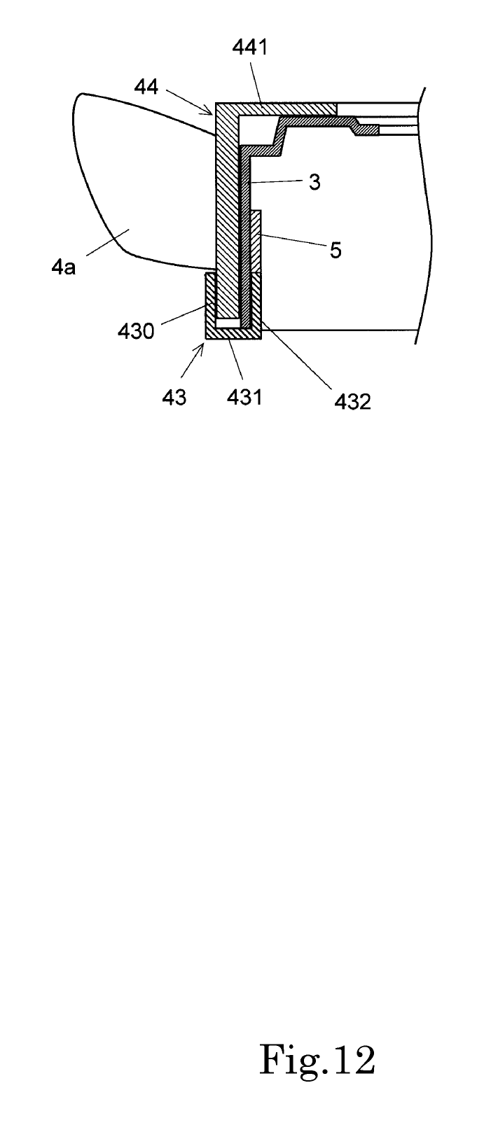

FIG. 12 is a diagram for illustrating a second modification of the second embodiment. As illustrated in FIG. 12, the magnet 5 of this modification is also disposed on the inner circumferential surface of the rotor holder 3. However, in this modification, the lower surface of the magnet 5 and the upper surface of the wall 432 face each other in the axial direction, unlike the first modification of the second embodiment. In other words, the wall 432 overlaps with the magnet 5 in plan view from the axial direction. The lower part of the cup portion 441 and the lower part of the rotor holder 3 are located between the inner circumferential surface of the cylindrical portion 430 and the radially outer surface of the wall 432, and the first member 43 is fixed to the cup portion 441 and the rotor holder 3. For fixation, press-fitting or adhesion may be used, for example.

In this modification, the bottom 431 extends radially inward across the inner circumferential surface of the rotor holder 3. The wall 432 is disposed at the radially extending portion of the bottom 431 across the inner circumferential surface of the rotor holder 3. In this modification, when the first member 43 is going to rise with respect to the rotor holder 3, the bottom 431 abuts against the rotor holder 3, and the wall 432 abuts against the magnet 5. This prevents the first member 43 from rising with respect to the rotor holder 3.

In this modification, the cup portion 441 and the rotor holder 3 are held between the inner circumferential surface of the cylindrical portion 430 and the radially outer surface of the wall 432. However, this is given for illustrative purpose. The cup portion 441, the rotor holder 3, and the magnet 5 may be held between the inner circumferential surface of the cylindrical portion 430 and the radially outer surface of the wall 432. In this case, when the first member 43 is going to rise with respect to the rotor holder 3, the bottom 431 abuts against the rotor holder 3 and the magnet 5, preventing the first member 43 from rising with respect to the rotor holder 3.

The present disclosure can be used for fan motors, for example.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A fan motor comprising:
a rotating portion configured to rotate about a central axis that extends vertically;
wherein the rotating portion comprises:
a rotor holder including a magnet; and
an impeller located outside the rotor holder and comprising a plurality of blades,
wherein the impeller comprises:
a first member comprising a cylindrical portion located radially outside the rotor holder; and
a second member disposed above the first member,
wherein the first member comprises a bottom at a lower end of the cylindrical portion, the bottom extending radially inward, and
wherein at least part of an upper surface of the bottom faces a lower surface of the rotor holder in an axial direction.

2. The fan motor according to claim 1, wherein the plurality of the blades are provided around an outer circumferential surface of the cylindrical portion.

3. The fan motor according to claim 2, wherein a lower surface of the rotor holder and an upper surface of the bottom are in contact with each other.

4. The fan motor according to claim 2,
wherein the second member comprises:
a top face extending in a radial direction; and
a protruding portion extending downward from the top face,
wherein an outer circumferential surface of the rotor holder and a radially inner surface of the protruding portion face each other in the radial direction.

5. The fan motor according to claim 4,
wherein an upper surface of the top face comprises a plurality of recessed portions recessed downward, and
wherein the plurality of recessed portions are arranged at intervals in a circumferential direction.

6. The fan motor according to claim 4, wherein the protruding portion comprises a plurality of protruding pieces disposed at intervals in the circumferential direction.

7. The fan motor according to claim 6, wherein a gap is provided between a lower surface of the top face and an upper surface of the rotor holder.

8. The fan motor according to claim 4,
wherein the cylindrical portion comprises:
a first side wall to which inner ends of the blades are connected; and
a second side wall located radially inside the first side wall, the second side wall comprising the bottom,
wherein an upper surface of the second side wall is located lower than an upper surface of the first side wall,
wherein a lower surface of the protruding portion and the upper surface of the second side wall face each other in the axial direction, and
wherein a radially outer side of the protruding portion and a radially inner side of the first side wall face each other in the radial direction.

9. The fan motor according to claim 8, wherein the cylindrical portion comprises a through-hole passing therethrough in the axial direction between the first side wall and the second side wall.

10. The fan motor according to claim 8,
wherein the protruding portion is located radially inside with respect to a radially outer end of the top face, and
wherein a lower surface of the radially outer end of the top face and the upper surface of the first side wall are in contact with each other.

11. The fan motor according to claim 10,
wherein an upper part of an outer circumferential surface of the first side wall comprises a first inclined surface inclined with respect to the central axis,
wherein a radially outer end face of the top face comprises a second inclined surface inclined with respect to the central axis, and
wherein the first inclined surface and the second inclined surface are inclined at a same angle.

12. The fan motor according to claim 2,
wherein the magnet is disposed on an inner circumferential surface of the rotor holder, and
wherein a lower surface of the magnet and the upper surface of the bottom face each other in the axial direction.

13. The fan motor according to claim 2,
wherein the rotating portion further comprises:
a shaft extending along the central axis; and
a housing that supports the shaft,
wherein the rotor holder is fixed to the housing,
wherein the second member comprises a top face extending in the radial direction, and
wherein the housing and the top face are joined together.

14. The fan motor according to claim 1,
wherein the second member comprises:
a cup portion that opens downward, the cup portion housing the rotor holder therein; and
the plurality of blades disposed around an outer circumferential surface of the cup portion,
wherein a lower surface of the cup portion and the upper surface of the bottom face each other in the axial direction, and
wherein an inner circumferential surface of the cylindrical portion faces the outer circumferential surface of the cup portion in the radial direction.

15. The fan motor according to claim 14,
wherein the cup portion comprises a step portion at which a radius from the central axis to the outer circumferential surface changes,
wherein a part of the cup portion lower than the step portion is smaller in radius than a part of the cup portion higher than the step portion,
wherein the cylindrical portion is located lower than the step portion, and
wherein an outer circumferential surface of the cup portion higher than the step portion and the outer circumferential surface of the cylindrical portion are flush with each other.

16. The fan motor according to claim 14,
wherein the bottom comprises a wall disposed radially inside the cylindrical portion, the wall extending upward, and
wherein the cup portion is located between the cylindrical portion and the wall.

17. The fan motor according to claim 15,
wherein the magnet is disposed on an inner circumferential surface of the rotor holder, and
wherein a lower surface of the magnet and an upper surface of the wall face each other in the axial direction.
